(19) United States
(12) Patent Application Publication
(10) Pub. No.: US 2009/0063725 A1
(43) Pub. Date: Mar. 5, 2009

(54) Direct memory access system

(75) Inventors: Welhua Zhang, Chengdu (CN); Shaohua Gui, Shanghai (CN); Xianxue Fu, Beijing (CN); Jianwei Dai, Storrs Mansfield, CT (US)

Correspondence Address: PATENT PROSECUTION;O2MIRCO , INC., 3118 PATRICK HENRY DRIVE, SANTA CLARA, CA, 95054, US

(73) Assignee: O2Micro Inc.

(21) Appl. No.: 11/897,635

(22) Filed: Aug. 31, 2007

(51) Int. Cl. G06F 13/28; G06F 13/24

(52) U.S. Cl. 710/22; 710/260

(57) ABSTRACT

A direct memory access (DMA) system is disclosed herein. The DMA system includes a controller and an interrupt processing unit. The controller is coupled to a first module and a second module for controlling transferring data between the first module and the second module. The data is modulated into a plurality of data blocks. The interrupt processing unit is coupled to the controller for receiving an interrupt from the first module indicative of transferring a data block of the plurality of data blocks, and for generating a drive signal to the controller indicative of transferring the data block of the plurality of data blocks. The plurality of data blocks are transferred between the first module and the second module in sequence according to a parameter value stored in the controller.

### FIELD OF THE INVENTION

The present invention relates to a data transfer system and more particularly to a direct memory access (DMA) system.

### BACKGROUND OF THE INVENTION

A direct memory access (DMA) method is developed in digital computer systems to transfer data between modules through a system bus. During a DMA transfer process, a controller can take over a control right of the system bus for the duration of the DMA transfer, or can transfer one data block each time the system bus is otherwise idle. A conventional DMA transfer can operate in a burst transfer mode, in which the DMA transfer is continuously performed until a required number of data are transferred after a right to control the bus by the controller is acquired. The conventional DMA transfer can also work in a cycle stealing transfer mode, in which a right to control a bus by the controller is acquired for each transfer of a data block. In such cycle stealing transfer mode, the DMA transfer is performed every time the right to control the bus is acquired by the controller, and the bus is released after a data block is transferred. A DMA request for transferring a next data block is required to be approved by a micro control unit (MCU) before processing the DMA transfer of the next data block.

In the conventional DMA system as described hereinabove, a DMA request bus is required for transferring a DMA request from a module to the MCU. The MCU configures DMA transfer parameter values each time through a system bus before one data block is transferred. Also, the MCU processes an interrupt after each data block is transferred. As a result, the MCU is required to monitor the whole process of DMA transfer and cannot be released from the DMA system during DMA transfer. Generally, huge system resource and time are consumed in conventional DMA systems.

### BRIEF SUMMARY OF THE INVENTION

A direct memory access (DMA) system is disclosed herein. The DMA system includes a controller and an interrupt processing unit. The controller is coupled to a first module and a second module for controlling transferring data between the first module and the second module. The data is modulated into a plurality of data blocks. The interrupt processing unit is coupled to the controller for receiving an interrupt from the first module indicative of transferring a data block of the plurality of data blocks, and for generating a drive signal to the controller indicative of transferring the data block of the plurality of data blocks. The plurality of data blocks are transferred between the first module and the second module in sequence according to a parameter value stored in the controller.

### BRIEF DESCRIPTION OF THE DRAWINGS

Advantages of the present invention will be apparent from the following detailed description of exemplary embodiments thereof, which description should be considered in conjunction with the accompanying drawings, in which:

FIG. 1 is a block diagram of a direct memory access (DMA) system, in accordance with one embodiment of the present invention.

FIG. 2 is a block diagram of a DMA system, in accordance with one embodiment of the present invention.

FIG. 3 is a flowchart of a DMA method, in accordance with one embodiment of the present invention.

### DETAILED DESCRIPTION OF THE INVENTION

The present invention illustrates a direct memory access (DMA) system and method which are different from a conventional DMA system and method. Since the embodiments shown in the drawings are for illustrative purposes, some sub-components and/or peripheral components generally incorporated in the invention are omitted herein for brevity and clarity. In describing the embodiments in accordance with the present invention, specific terminologies are employed for the sake of clarity. However, the disclosure of this patent specification is not intended to be limited to the selected terminology and the specified embodiments. It is understood that each specific element includes all technical equivalents that operate in a similar manner.

In one embodiment, the present invention provides a direct memory access (DMA) system and method for transferring data between a first module and a second module via a system bus. In one such embodiment, the DMA system includes a controller coupled to the first module and the second module for controlling transferring data between the first module and the second module. The data can be modulated to a plurality of data blocks which are transferred in sequence between the first module and the second module. The DMA system also includes an interrupt processing unit coupled to the controller for receiving an interrupt from the first module indicative of transferring a data block of the plurality of data blocks, and for generating a drive signal to the controller indicative of transferring the data block. The plurality of data blocks are transferred between the first module and the second module in sequence according to a parameter value stored in the controller, in one embodiment. The parameter value is configured in the controller before the plurality of data blocks are transferred, in one embodiment. Advantageously, a processor does not need to configure the controller with the parameter value via a system bus each time a data block is transferred, thereby reducing processing time and system resource.

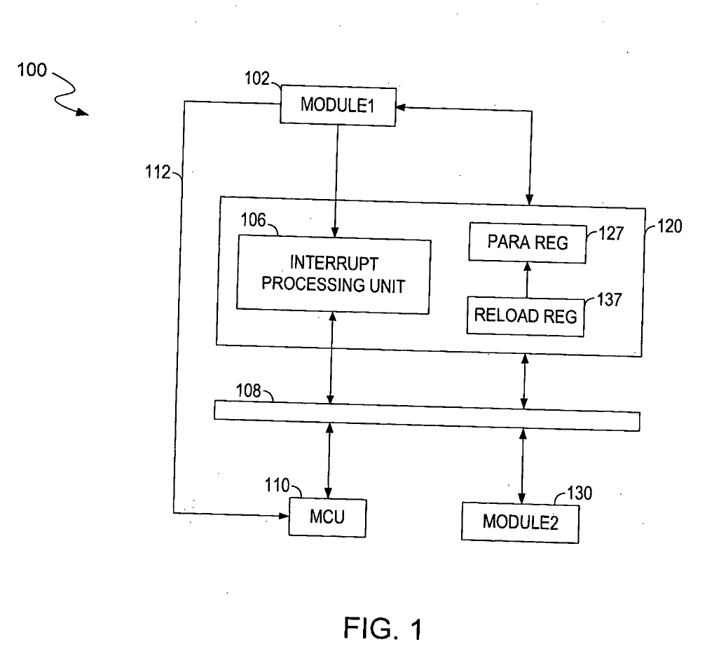

FIG. 1 illustrates a block diagram of a DMA system 100, in accordance with one embodiment of the present invention. The DMA system 100 includes a processor (e.g., a micro control unit (MCU)) 110, a first module 102, a second module 130, a controller 120, and an interrupt processing unit 106, in one embodiment. The DMA system 100 also includes a bus 108 (e.g., an advanced high performance bus (AHB)) coupled to modules 102 and 130, the controller 120 and the interrupt processing unit 106, in one embodiment. Modules 102 and 130 can include, but are not limited to, interfaces that can be used to couple external devices to the DMA system 100, e.g., a USB engine that can be used to couple a USB device to the DMA system 100, a media controller that can be used to couple a media to the DMA system 100, etc. The modules 102 and 130 can also include, but are not limited to, devices that can be coupled to the bus 108 via interfaces, e.g., mass storage device, USB device, printer, scanner, media, etc. The interrupt processing unit 106 can be integrated in the controller 120 as shown in FIG. 1, or can be built external to the controller 120.

When data is required to be transferred between the first module 102 and the second module 130, e.g., from the first module 102 to the second module 130, the first module 102 generates an interrupt (which indicates a data transfer request) to the MCU 110 via an interrupt line 112, in one embodiment. The data is modulated to a plurality of data blocks, in one embodiment. The MCU 110 can be used to configure the controller 120 with a parameter value according to a command block wrapper (CBW) before the plurality of data blocks are transferred. The CBW indicates control information of the data, in one embodiment. More specifically, the MCU 110 configures a parameter register 127 and a reload register 137 of the controller 120 with a parameter value, in one embodiment. The first module 102 generates an interrupt to the interrupt processing unit 106 each time when a data block is to be transferred, in one embodiment. The interrupt processing unit 106 can inform the controller 120 to transfer the data block according to the parameter value in the parameter register 127. The controller 120 can load the parameter value from the reload register 137 to the parameter register 127 after the data block is transferred successfully.

Advantageously, the MCU 110 does not need to configure the controller 120 via the system bus 208 each time a data block is transferred.

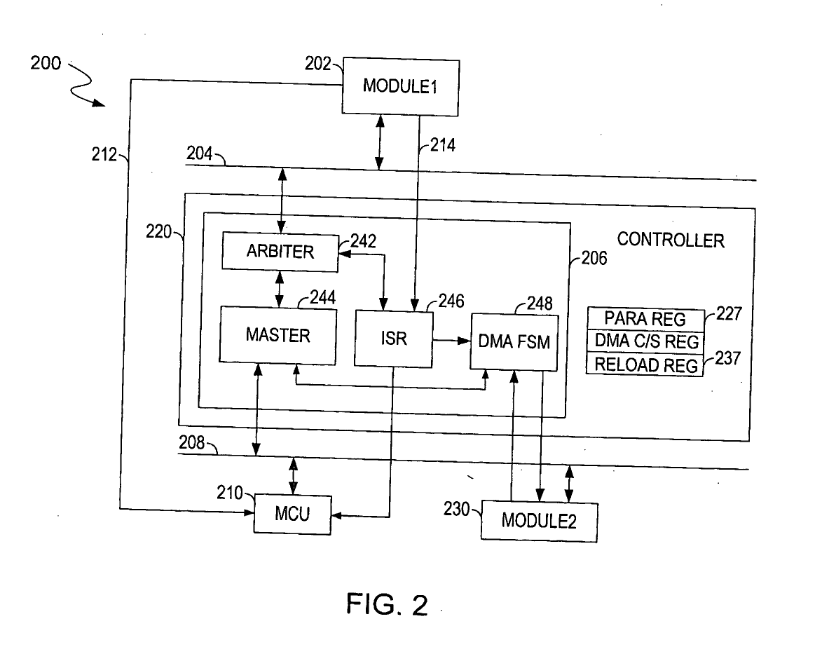

FIG. 2 illustrates a block diagram of a DMA system 200, in accordance with one embodiment of the present invention. The DMA system 200 includes a MCU 210, a first module 202 (e.g., a USB engine), a first bus 204 (e.g., a wishbone bus (WB) or an advanced high performance bus (AHB)), a second bus 208 (e.g., a WB or an AHB), a second module 230 (e.g., a media controller), a controller 220, and an interrupt processing unit 206, in one embodiment. In one embodiment, the controller 220, the interrupt processing unit 206, the MCU 210, the first module 202, and the second module 230 have similar functions as the controller 120, the interrupt processing unit 106, the MCU 120, the first module 102, and the second module 130 respectively as shown in FIG. 1. Hence, any repetitive description will be omitted herein for purposes of clarity and brevity. In one embodiment, the first module 202 writes/sends data to the second module 230 (that is, data is transferred from the first module 202 to the second module 230).

In one embodiment, the interrupt processing unit 206 includes an interrupt service routine (ISR) 246 for receiving an interrupt from the first module 202 indicative of transferring a data block. The interrupt processing unit 206 can also includes a DMA finite state machine (FSM) 248 for generating a drive signal to the controller indicative of transferring the data block. More specifically, the ISR 246 is used for receiving the interrupt from the first module 202 and for generating a transfer signal in response to the interrupt, in one embodiment. The FSM 248 can be used for receiving the transfer signal from the ISR 246, for receiving a request signal from the second module 230, and for generating the drive signal in response to the transfer signal and the request signal, in one embodiment.

The interrupt processing unit 206 can also includes an arbiter 242 and a master 244. In one embodiment, the arbiter 242 is employed to select a state of the first bus 204. More specifically, the first bus 204 can be assigned to the master 244 for transferring data or assigned to the ISR 246 for transferring control information (e.g., the ISR 246 processes an interrupt from the first module 202 via the first bus 204) under the control of the arbiter 242. In one embodiment, each data block can be transferred from the first module 202 to the first bus 204, from the first bus 204 to the second bus 208 under the control of the master 244, then from the second bus 208 to the second module 230.

In one embodiment, the first module 202 may be a USB engine. A USB device (not shown in FIG. 2) can be coupled to the DMA system 200 via the USB engine for transferring data to the second module 230. The USB device can store the data into a buffer (not shown in FIG. 2) of the first module 202. In one embodiment, the second module 230 may be a media controller. A media device (not shown in FIG. 2) can be coupled to the media controller for receiving the data from the first module 202. In one embodiment, the data to be transferred is modulated to a plurality of data blocks which are transferred in sequence from the first module 202 to the second module 230. The plurality of data blocks have a same predetermined length (e.g., 512 bytes), in one embodiment.

In operation, the first module 202 generates an interrupt to the MCU 210 via an interrupt line 212, if the data in the first module 202 is required to be transferred. The interrupt line 212 can be disabled after the MCU 210 configures the controller 220, in one embodiment. The MCU 210 will fetch a command block wrapper (CBW) from the first module 202 in response to the interrupt from the first module 202. The CBW indicates control information of the data, in one embodiment. In one embodiment, the CBW includes a transfer direction of the data, a length of the data, etc. In one embodiment, the data will be modulated into a plurality of data blocks which are transferred in sequence from the first module 202 to the second module 230. The MCU 210 configures the controller 220 with a parameter value according to the command block wrapper before the plurality of data blocks are transferred, in one embodiment. In one such embodiment, the parameter value may include, but is not limited to, a source address, a destination address, and a length of the data block.

The controller 220 may includes a parameter register 227 for storing the parameter value. The controller 220 can further include a reload register 237 for storing the parameter value. The parameter value can be loaded from the reload register 237 to the parameter register 227, since the parameter value in the parameter register 227 may be changed during transfer, in one embodiment. In other words, the reload register 237 can be used to back up parameter value, in one embodiment. In one embodiment, the parameter register 227 includes a source sub-register (not shown in FIG. 2) for storing the source address, a destination sub-register (not shown in FIG. 2) for storing the destination address, and a length sub-register (not shown in FIG. 2) for storing the length of the data block. The reload register 237 includes a source sub-register (not shown in FIG. 2) for storing the source address, a destination sub-register (not shown in FIG. 2) for storing the destination address and a length sub-register (not shown in FIG. 2) for storing the length of the data block.

The first module 202 generates an interrupt to the ISR 246 via an interrupt line 214 if a data block of the plurality of data blocks in the buffer of the first module 202 is ready to be transferred, in one embodiment. The ISR 246 can be used to process the interrupt from the first module 202 and sends a transfer signal to the DMA FSM 248 indicating that a data block at the first module 202 is ready to be transferred. In one embodiment, the DMA FSM 248 can also receive a request signal from the second module 230, e.g., a DMA request signal indicative of data acquiring of the second module 230. As a result, the DMA FSM 248 will generate a drive signal to the controller 220 indicative of transferring the data block. As such, the drive signal is generated in response to the transfer signal from the ISR 246 and the request signal from the second module 230, in one embodiment. The master 244 can be used to transfer the data block from the first bus 204 to the second bus 208. Consequently, the data block can be transferred from a buffer of the first module 202 to a buffer of the second module 230 via the first bus 204 and the second bus 208.

In one embodiment, the controller 220 includes a counter (not shown in FIG. 2). The counter (e.g., a byte counter) can be initialized with a value indicative of a length of a data block, before the data block is transferred. The value in the counter decreases gradually during a time period when the data block is being transferred. The value of the counter decreases to zero if the data block is transferred from the first module 202 to the second module 230 completely, in one embodiment. After the data block is transferred completely, the controller 220 can load the parameter value from the reload register 237 to the parameter register 227 for transferring a next data block. The counter is then initialized with a value indicating a length of the next data block.

In one embodiment, the first module 202 generates an interrupt to the ISR 246 via the interrupt line 214 if a next data block of the plurality of data blocks from the first module 202 is ready to be transferred. Similarly, the ISR 246 generates a transfer signal indicative of transferring the next data block to the DMA FSM 248. In such condition, if the DMA FSM 248 also receives a request signal from the second module 230 indicative of a data acquiring, the next data block will be transferred according to the parameter value in the parameter register 227 in a similar way as the abovementioned data block. Sequentially, other data blocks can be transferred in a similar way.

After all the data blocks are transferred completely, the ISR 246 generates an interrupt to the MCU 210 indicating all the data blocks are transferred completely, in one embodiment. The MCU 210 can in turn transfer a command status wrapper (CSW) to the first module 202, which indicates an end of the data transfer. The device coupled to the first module 202 can fetch the CSW from the first module 202. The data transfer ends. The interrupt line 214 is disabled and the interrupt line 212 is enabled once the data transfer ends, in one embodiment. As such, the MCU 210 can receive an interrupt from the first module 102 indicative of another data transfer request.

Furthermore, a predetermined situation may happen during the data transfer. The predetermined situation may include an error when transferring a data block. If an error occurs, the interrupt processing unit 206 will notify the MCU 210 about the error, in one embodiment. Then the MCU 210 will instruct the controller 220 to operate according to preset programs, such as to re-transfer the data block where the error occurs, or to terminate the DMA transfer, etc.

In one embodiment, the first module 202 may also read/receive data from the second module 230. Thus, data can be transferred from the second module 230 to the first module 202 under the control of the controller 220 in a similar manner as the first module 202 writes/sends data to the second module 230, as illustrated hereinabove. In one embodiment, the first module 202 can generate an interrupt to the interrupt processing unit 206 each time after the first module 202 reads/receives a data block from the second module 230. In one embodiment, the second module 230 can read/write data from/to the first module 202 similarly. The controller 220 can also control data transfer between other devices coupled to the bus 208, such as between the module 202 and the MCU 210.

In one embodiment, the DMA system 200 may include a mode arbiter (not shown in FIG. 2) for selecting a mode between a first transferring mode and a second transferring mode. In the first transferring mode, the MCU 210 can configure the parameter register 227 and the reload register 237 with the parameter value before the data is transferred. The interrupt processing unit 206 processes an interrupt from the first module 202 indicative of transferring a data block. In one embodiment, the interrupt processing unit 206 also receives a request signal from the second module 230 indicative of acquiring data from the first module 202. The interrupt processing unit 206 can further generate a drive signal to the controller 220 indicative of transferring the data block. The drive signal is generated based on the request signal from the second module 230 and the interrupt from the first module 202. In response to the drive signal, the controller 220 transfers the data block and loads the parameter value from the reload register 237 to the parameter register 227 for transferring a next data block until all the data blocks have been transferred successfully. Advantageously, the MCU 210 can be released during the data transfer process after the MCU 210 configures the controller 220 in the first transferring mode.

In the second transferring mode, instead of the interrupt processing unit 206, the MCU 210 processes an interrupt from the first module 202 indicative of transferring a data block. In one embodiment, the MCU 210 can also receive a request signal from the second module 230 indicative of acquiring data from the first module 202. The MCU 210 can further generate a drive signal to the controller 220 indicative of transferring the data block. The drive signal is generated based on the request signal from the second module 230 and the interrupt from the first module 202, in one embodiment. In response to the drive signal, the controller 220 transfers the data block. In the second transferring mode, the reload register 237 can be disabled, such that the MCU 210 configures the parameter register 227 with a parameter value via the bus 208, each time when a data block is to be transferred, in one embodiment.

The mode arbiter can be implemented by various configurations. In one embodiment, the mode arbiter may include a register that can be configured by the MCU 210. The register stores information such as which mode is selected (the first transferring mode or the second transferring mode). The register can be developed or configured with other functions, according to different implementations and/or requirements.

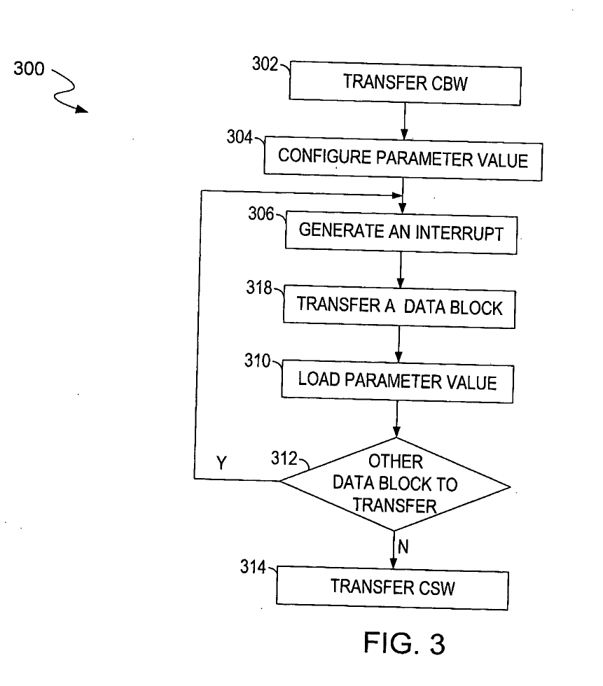

FIG. 3 illustrates a flowchart 300 of operations performed by a DMA system for transferring data from a first module to a second module, in accordance with one embodiment of the present invention. FIG. 3 is described in combination with FIG. 1 and/or FIG. 2.

At step 302, the first module 102 (202) transfers a command block wrapper (CBW) of the data to the MCU 110 (210). At step 304, the MCU 110 (210) configures the parameter register 127 (227) and the reload register 137 (237) of the controller 120 (220) with the parameter value according to the CBW of the data. In one embodiment, the flowchart 300 may further include a step (not shown in FIG. 3) of modulating the data to a plurality of data blocks. In one embodiment, the plurality of data blocks have a same predetermined length. The plurality of data blocks will be transferred according to the parameter value stored in the controller 120 (220), and the parameter value is configured in the controller 120 (220) before transferring the plurality of data blocks, in one embodiment. In one embodiment, the flowchart 300 may further includes a step (not shown in FIG. 3), in which the controller 120 (220) obtains a control right of the bus 108 (208) before transferring the plurality of data blocks.

At step 306, the first module 102 (202) generates an interrupt to the interrupt processing unit 106 (206) indicative of transferring a data block. In one embodiment, the flowchart 300 may further include a step (not shown in FIG. 3), in which the second module 130 (230) generates a request signal to the interrupt processing unit 106 (206) indicative of a data acquiring. In one embodiment, the flowchart 300 may further include a step (not shown in FIG. 3), in which the interrupt processing unit 106 (206) generates a drive signal to the controller 120 (220) indicative of transferring the data block. The drive signal is generated according to the interrupt from the first module 102 (202) and the request signal from the second module 130 (230). At step 318, the first module 102 (202) transfers the data block to the second module 130 (230) according to the parameter value in the parameter register 127 (227) of the controller 120 (220). At step 310, the controller 120 (220) loads the parameter value from the reload register 137 (237) to the parameter register 127 (227) after the data block is transferred from the first module 202 to the second module 230 completely.

At step 312, if a next data block of the plurality of data blocks is required to be transferred from the first module 102 (202) to the second module 130 (230), the flowchart 300 returns to step 306. Accordingly, the next data block is transferred similarly as the abovementioned approach until all the data blocks are transferred from the first module 202 to the second module 230 successfully. In one embodiment, if no data block is required to be transferred from the first module 102 (202) to the second module 130 (230) at step 312, the MCU 110 (210) transfers a command status wrapper (CSW) to the first module 102 (202) indicative of a completion of the data transfer. In one embodiment, the flowchart 300 may further includes a step (not shown in FIG. 3) at which the controller 120 (220) releases the control right of the bus 108 (208). Thus, the data transfer between the first module 102 (202) and the second module 130 (330) ends.

In one embodiment, the flowchart 300 may further includes a step (not shown in FIG. 3) at which the second module 130 demodulates the plurality of data blocks to the original data after the DMA transfer is completed.

Accordingly, a DMA system is provided for transferring data from a first module to a second module under control of a controller. The data is modulated to a plurality of data blocks. The controller includes a parameter register and a reload register for storing a parameter value. An interrupt processing unit processes an interrupt from the first module indicative of transferring a data block and receives a request signal from the second module indicative of a data requiring. The interrupt processing unit generates a drive signal to the controller indicative of transferring the data block in response to the request signal from the second module and the interrupt from the first module. Thus, the next data block is transferred according to the parameter value in the parameter register under control of the controller. After the data block is transferred successfully, the controller loads the parameter value from the reload register to the parameter register for transferring a next data block. The data transfer ends until the plurality of data blocks are transferred successfully.

The embodiments that have been described herein, however, are but some of the several that utilize this invention and are set forth here by way of illustration but not of limitation. It is obvious that many other embodiments, which will be readily apparent to those skilled in the art, may be made without departing materially from the spirit and scope of the invention as defined in the appended claims. Furthermore, although elements of the invention may be described or claimed in the singular, the plural is contemplated unless limitation to the singular is explicitly stated.

What is claimed is:

1. A direct memory access (DMA) system comprising:
a controller coupled to a first module and a second module operable for controlling transferring data between said first module and said second module, wherein said data is modulated into a plurality of data blocks; and
an interrupt processing unit coupled to said controller operable for receiving an interrupt from said first module indicative of transferring a data block of said plurality of data blocks, and for generating a drive signal to said controller indicative of transferring said data block,
wherein said plurality of data blocks are transferred between said first module and said second module in sequence according to a parameter value stored in said controller.

2. The DMA system of claim 1, further comprising:
a processor operable for configuring said controller with said parameter value according to a command block wrapper before said plurality of data blocks are transferred,
wherein said command block wrapper indicates control information of said data.

3. The DMA system of claim 1, wherein said plurality of data blocks have a same predetermined length.

4. The DMA system of claim 3, wherein said parameter value comprises a source address, a destination address, and said predetermined length.

5. The DMA system of claim 1, wherein said controller comprises a parameter register for storing said parameter value.

6. The DMA system of claim 5, wherein said controller further comprises a reload register for storing said parameter value, and wherein said parameter value is capable of being loaded from said reload register to said parameter register.

7. The DMA system of claim 1, wherein said interrupt processing unit comprises an interrupt service routine operable for receiving said interrupt from said first module.

8. The DMA system of claim 1, wherein said interrupt processing unit comprises a finite state machine operable for generating said drive signal to said controller indicative of transferring said data block.

9. The DMA system of claim 1, wherein said interrupt processing unit comprises:
an interrupt service routine operable for receiving said interrupt from said first module and for generating a transfer signal in response to said interrupt; and
a finite state machine operable for receiving said transfer signal from said interrupt service routine, for receiving a request signal from said second module, and for generating said drive signal in response to said transfer signal and said request signal.

10. The DMA system of claim 9, wherein said request signal indicates a data acquiring of said second module.

11. A direct memory access (DMA) system comprising:
a controller coupled to a first module and a second module operable for controlling transferring data between said first module and said second module, wherein said data is modulated into a plurality of data blocks;
a processor coupled to said controller operable for configuring said controller with a parameter value before said plurality of data blocks are transferred; and
an interrupt processing unit operable for receiving an interrupt from said first module indicative of transferring a data block of said plurality of data blocks, and for generating a drive signal to said controller indicative of transferring said data block,
wherein said plurality of data blocks are transferred between said first module and said second module in sequence according to said parameter value stored in said controller.

12. The DMA system of claim 11, wherein said controller comprises:
a parameter register for storing said parameter value; and
a reload register for storing said parameter value,
wherein said parameter value is capable of being loaded from said reload register to said parameter register.

13. The DMA system of claim 11, wherein said plurality of data blocks have a same predetermined length.

14. The DMA system of claim 11, wherein said interrupt processing unit comprises an interrupt service routine operable for receiving said interrupt from said first module.

15. The DMA system of claim 11, wherein said interrupt processing unit comprises a finite state machine operable for generating said drive signal to said controller.

16. The DMA system of claim 11, wherein said interrupt processing unit comprises:
an interrupt service routine operable for receiving said interrupt from said first module and for generating a transfer signal in response to said interrupt; and
a finite state machine operable for receiving said transfer signal from said interrupt service routine, for receiving a request signal from said second module indicative of a data requiring of said second module, and for generating said drive signal to said controller in response to said transfer signal and said request signal.

17. A method for transferring data, comprising:
receiving an interrupt indicative of transferring a data block of a plurality of data blocks;
generating a drive signal indicative of transferring said data block in response to said interrupt; and
transferring said plurality of data blocks according to a parameter value stored in a controller which controls transferring said data between a first module and a second module,
wherein said parameter value is configured in said controller before transferring said plurality of data blocks.

18. The method of claim 17, further comprising:
configuring a first register of said controller and a second register of said controller with said parameter value.

19. The method of claim 17, further comprising:
loading said parameter value in a second register of said controller to a first register of said controller after said data block is transferred.

20. The method of claim 17, wherein said plurality of data blocks have a same predetermined length.

21. The method of claim 17, furthering comprising:
receiving a request signal indicative of a data acquiring; and
generating said drive signal in response to said interrupt and said request signal.

22. The method of claim 17, further comprising:
modulating said data to said plurality of data blocks before transferring said data; and
demodulating said plurality of data blocks to said data after said plurality of data blocks are transferred.

23. The method of claim 17, further comprising:
obtaining a control right of a bus before transferring said data; and
releasing said control right of said bus after said data is transferred.
